(19) United States
(12) Patent Application Publication
(10) Pub. No.: US 2004/0008825 A1
(43) Pub. Date: Jan. 15, 2004

(54) One script test script system and method for testing a contact center voice application

(76) Inventors: Albert Seeley, Burlington, MA (US); Zhongyi Chen, Burlington, MA (US); Wesley Hand, Londonderry, NH (US); Hengli Wang, Reading, MA (US); Douglas Williams, Acton, MA (US)

Correspondence Address: DALY, CROWLEY & MOFFORD, LLP, SUITE 101, 275 TURNPIKE STREET, CANTON, MA, 02021-2310, US

(21) Appl. No.: 10/600,964

(22) Filed: Jun. 20, 2003

Related U.S. Application Data
(60) Provisional application No. 60/390,775, filed on Jun. 21, 2002.

(51) Int. Cl. H04M 1/24; H04M 15/00

(52) U.S. Cl. 379/32.01; 379/27.02; 379/29.02; 379/112.01

(57) ABSTRACT

A one script system and method allow for generation of a test script associated with a virtual telephone caller system. The generated test script is generated such that it can be used for two or more of a functional test, a load test, and a monitoring test of the voice functions of a contact center.

### CROSS REFERENCE TO RELATED APPLICATIONS

This application claims the benefit of U.S. Provisional Application No. 60/390,775 filed Jun. 21, 2002 which application is hereby incorporated herein by reference in its entirety.

### STATEMENT REGARDING FEDERALLY SPONSORED RESEARCH

Not Applicable.

### FIELD OF THE INVENTION

This invention relates generally to testing of a contact center and more particularly to use of a single test script system to test the contact center in a variety of test contexts.

### BACKGROUND OF THE INVENTION

Computers have been applied as test computers associated with contact centers. Contact centers will be recognized as those systems to which a person can communicate to receive information. Such communication can include, but is not limited to, telephone calls, Internet access, email, and FAX.

A contact center can include one or more interactive voice response (IVR) systems. The one or more IVRs provide automatic branching voice queries to which the caller responds with button pushes on a telephone keypad or with voice responses on a telephone. The contact center is provided having only the one or more IVR systems, or alternatively, it is also provided having human agents. For example, at the end of the IVR branching voice queries, the caller can be directed to press zero to speak to an agent. The agent is a person having a telephone to talk to the caller, hereafter referred to as an “agent telephone,” and a computer to access information about the caller, hereafter referred to as an “agent computer.” Note that though the agent telephone and the agent computer are often associated with one person, they correspond to distinct electronic systems and will be separately referred to herein.

The contact center can also include one or more database server computers, one or more database storage areas, one or more web server computers, and one or more email server computers.

Various testing systems have been provided to test functions associated with the contact center. For example, the Hammer IT™ from Empirix, Inc. of Waltham, Mass., can be used to simulate telephone callers in a public switched telephone network (PSTN) having one or more telephone callers who access the contact center either sequentially or in parallel. The Hammer IT™ system provides a “virtual telephone caller system” having “virtual telephone callers” that can exercise and test the responses of the one or more IVR systems. The virtual telephone caller system can also be used to test the agent telephone functions of the contact center, providing a “virtual agent telephone system” having “virtual agent telephones.” The virtual telephone caller system can also be used to test FAX functions of the contact center.

Various testing systems have also been provided to test the agent computer function of the contact center. For example, the E-test™ system from Empirix Inc. can be used to simulate the computer functions of the agent computer, providing a “virtual agent computer system” having “virtual agent computers.” The E-test™ system can also provide a “virtual web user system” having “virtual web users” that include simulations of people who access web pages on a web server within the contact center, people who send/receive email associated with an email server within the contact center, and people who send/receive FAX information associated with a FAX system within the contact center. The virtual telephone caller systems, virtual agent telephone systems, virtual agent computer systems, and virtual web user systems will hereafter be referred to as “virtual test systems.” The overall prior art system is shown below in association with FIG. 1.

Virtual telephone caller systems have been provided that are programmed in a variety of ways. For example, the Hammer IT™ virtual telephone caller system described above can be programmed in Hammer Visual Basic. The Hammer Visual Basic program includes a test scripts that causes the virtual telephone caller system to perform a sequence of programmed tests of the contact center, and in particular, tests of the one or more IVR systems within the contact center. For example, the test scripts can be associated with simulated telephone caller queries to the IVR, such as simulated telephone keypad button pushes or simulated telephone caller voice commands.

Alternatively, a graphical user interface can be provided that allows the user to program the virtual telephone caller system using graphical icons that can be connected together in a “call flow diagram.” Such graphic user interfaces provide automatic test generation. For example, the Hammer CallMaster™ software system from Empirix, Inc. of Waltham, Mass., allows the user to interconnect icons on a graphical display, each icon representing an action (or set of actions) to be taken by the virtual telephone caller system, and the interconnections corresponding to a sequence of actions. The call flow diagram results in the automatic generation of the test scripts described above.

Call flow diagrams are created using a graphical call flow editor in conjunction with a standard library of call flow icons. Each call flow icon is associated with test code necessary to execute the call flow action and an appropriate set of default telephony parameters. These parameters can be overridden on either a global or instance basis. Users can also specify the data to be used in the tests.

Automatic test generation software is provided, (for example, as part of the Hammer CallMaster™ software system described above), that can exercise the variety of branches through the call flow diagram in a way prescribed by the user. The automatic test generation software eliminates the tedious, unreliable, and time-consuming process of manual test design and execution by giving users the power to automatically generate and execute tests derived from a call flow diagram.

By way of the automatic test generation software, test developers create automated tests simply by generating the call flow diagram. Using automatic test generation technology, the software then automatically generates a set of test scripts that are used to exercise all or part of the call flow paths and data in the call flow diagram. Under user control, tests can be generated to do focused testing of a new feature, or general functional testing of the entire application. Tests can be used for post-deployment monitoring and maintenance to ensure that the application continues to deliver the highest possible level of performance.

As described above, the virtual telephone caller system can be programmed in a programming language to directly provide the test scripts. Alternatively, as also described above, the user can generate the call flow diagram, and the system can automatically convert the call flow diagram to the test scripts. The test scripts act upon virtual telephone caller system hardware to provide simulated telephone calls and simulated telephone caller actions, such as telephone button pushes. Virtual telephone caller systems have used test scripts provided in a variety of software languages. Visual Basic based software is but one language that can be used by the user to program the virtual telephone caller systems.

The IVR system associated with a contact center can be tested in a variety of test contexts. The virtual telephone caller system has been applied to the variety of test contexts. For example, functional testing will be understood to be that testing generally performed before the IVR system is released to the public to verify that the IVR is properly functioning. The functional testing is generally performed by a designer of the IVR system. For another example, load testing will be understood to be that testing generally performed while the IVR system is in public use to verify that the IVR system can accommodate at least a certain number of simultaneous telephone calls. The load testing is generally performed by a contact center manager. Alternatively, the load testing can be performed while the IVR system is not in public use. For yet another example, monitoring testing will be understood to be that testing also generally performed while the IVR system is in public use to verify that the IVR system is operational. The monitoring testing is also generally performed by the contact center manager but in an automatic background mode.

It should be appreciated that the functional testing, the load testing, and the monitoring testing, each have different requirements. For example, a designer of the IVR system using a functional test may want to test each of the variety of paths through the call flow diagram, i.e. each path through the variety of branching call options presented to a telephone caller. In functional testing it may only be necessary to provide a single virtual telephone caller which exercises in sequence most or all of the possible paths through the call flow diagram. For another example, a contact center manager using a load test may want to test only some of the variety of paths through the call flow diagram. In load testing, it is desirable to provide a large number of virtual telephone callers to test the delay time latencies that can be caused by many simultaneous telephone callers. For yet another example, a contact center manager using a monitoring test may want to minimally test the general operation of the contact center from time to time. In monitoring testing it may only be necessary to provide a single virtual telephone caller, thereby exercising one or a small number of paths through the call flow diagram.

Therefore, the test scripts associated with the functional test, the test scripts associated with the load test, and the test scripts associated with the monitoring test have been conventionally provided as separate test scripts. The separate tests scripts have required separate engineering time and budget to generate the separate tests scripts.

It would, therefore, be desirable to overcome the aforesaid and other disadvantages.

### SUMMARY OF THE INVENTION

The present invention provides a virtual telephone caller test script system and method, wherein the test scripts are used to test an interactive voice response system (IVR), and for which the test scripts, whether manually generated or automatically generated, provide the user with the ability to use the test scripts in two or more of a functional test, a load test, and a monitoring test. With this particular arrangement, the test scripts can be used in a variety of tests, and only one, or a minimum number, of test scripts thus need to be generated to test the contact center in a variety of test scenarios.

In accordance with the present invention, a method for generating a test script associated with a virtual telephone caller system used to test a contact center includes receiving a test script having test script portions, and associating script parameters with at least one of the test script portions, wherein the script parameters are related to a behavior of the test script that allows the test script to provide two or more of a functional test, a load test, and a monitoring test.

In accordance with another aspect of the present invention, a computer program medium having computer readable code thereon for testing a contact center includes instructions for receiving a test script having test script portions, and instruction for associating script parameters with at least one of the test script portions, wherein the script parameters are related to a behavior of the test script that allows the test script to provide two or more of a functional test, a load test, and a monitoring test.

In accordance with another aspect of the present invention, an apparatus for testing a contact center includes a graphical user interface adapted to allow a user to provide script parameters to a test scrip that allow the test script to be run in two or more of a functional test, a load test, and a monitoring test.

With this particular arrangement, the engineering, the required to generate test scripts is minimized.

### BRIEF DESCRIPTION OF THE DRAWINGS

The foregoing features of the invention, as well as the invention itself may be more fully understood from the following detailed description of the drawings, in which:

FIG. 1 is a block diagram of a prior art contact center in association with a variety of virtual test systems;

FIG. 2 is a block diagram of a prior art virtual telephone caller system coupled to a contact center;

FIG. 3 is a chart showing a prior art call flow diagram;

FIG. 4 is a flow chart showing an exemplary process in accordance with the present invention;

FIG. 5 is an exemplary graphical user interface in accordance with the present invention;

FIG. 6 is another exemplary graphical user interface in accordance with the present invention;

FIG. 7 is another exemplary graphical user interface in accordance with the present invention;

FIG. 8 is yet another exemplary graphical user interface in accordance with the present invention;

FIG. 9 is yet another exemplary graphical user interface in accordance with the present invention;

FIG. 10 is yet another exemplary graphical user interface in accordance with the present invention;

FIG. 11 is yet another exemplary graphical user interface in accordance with the present invention;

FIG. 12 is yet another exemplary graphical user interface in accordance with the present invention;

FIG. 13 is yet another exemplary graphical user interface in accordance with the present invention;

FIG. 14 is yet another exemplary graphical user interface in accordance with the present invention;

FIG. 15 is yet another exemplary graphical user interface in accordance with the present invention; and

FIG. 16 is yet another exemplary graphical user interface in accordance with the present invention.

### DETAILED DESCRIPTION OF THE INVENTION

Before describing the one script system and method, some introductory concepts and terminology are explained. As used herein, the term “virtual telephone callers” is used to describe simulated telephone callers provided by a “virtual telephone caller system” that generates simulated telephone signals corresponding to a public switched telephone network (PSTN). The term “virtual web users” is used to describe simulated web page users provided by a “virtual web user system” that generates simulated Internet signals corresponding to the Internet. The term “agent” will be used herein to describe a person at a contact center who responds to a telephone caller. The term “virtual agent telephone” is used herein to describe a simulation of the verbal responses of an agent at a contact center, provided by a “virtual agent telephone system.” The term “virtual agent computer” is used herein to describe a simulation of the computer display provided to the agent at a contact center, provided by a “virtual agent computer system.”

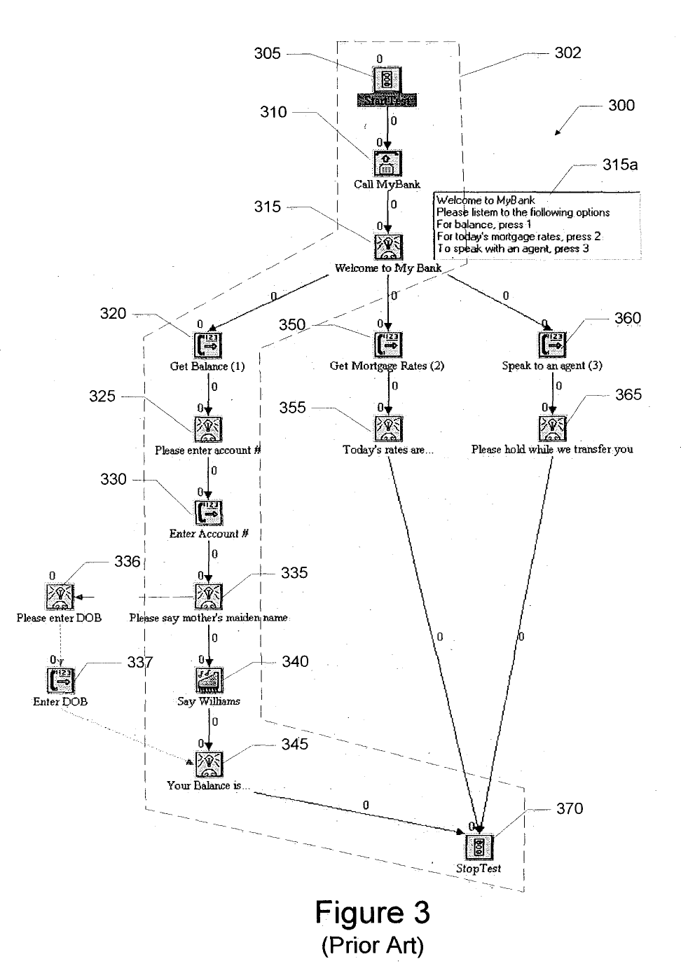

The term “test script,” as used herein, refers to the software test script that underlies one of the variety of paths (e.g., 302, FIG. 3) through a call flow diagram (e.g., 300, FIG. 3).

The term “script parameters,” as used herein, refers to data that can be an input to or an output from a test script, also an input to or an output from a portion of the test script. A script parameter can correspond, for example, to a text string that, in turn, corresponds to a voice response provided by a virtual telephone caller system. A script parameter can also correspond, for another example, to a voice response generated by a contact center and received by the virtual telephone caller system whereupon it is converted to a text string. A script parameter can also correspond, for another example, to a text string associated with the virtual telephone caller system corresponding to an expected voice response from the contact center. A script parameter can also correspond, for another example, to a time latency value measured by the virtual telephone caller system. A script parameter can also correspond, for another example, to a variety of thresholds and a variety of error conditions. An error condition, for example, can correspond to an inaudible response from the contact center received by the virtual telephone caller system, or a delayed response from the contact center. The above examples are but a few of the script parameters that can be associated with a test script or test script portion.

A “call flow path,” as used herein, refers to a translation along a path of interconnected icons (e.g., 302, FIG. 3), corresponding to associated actions provided by the virtual telephone caller system and associated responses from the contact center. It will be appreciated that there can be a large number of call flow paths incorporated in a call flow diagram.

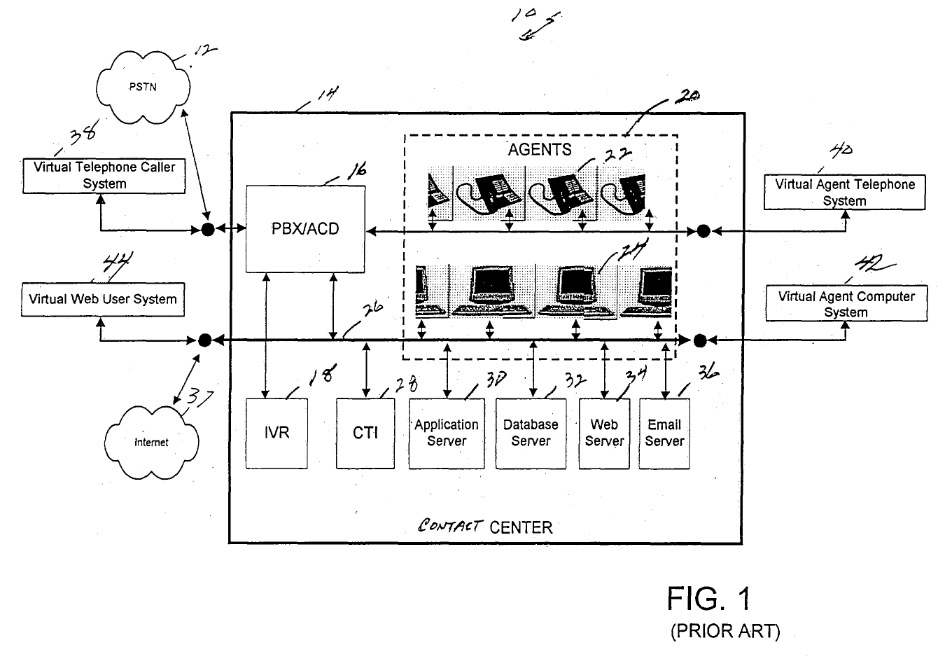

Referring now to FIG. 1, a prior art contact center and test system 10 is connected to the public switched telephone network 12 (PSTN). The PSTN will be recognized to be the worldwide telephone system that provides telephone call connections, including telephone connections to a contact center 14. The contact center 14 can include a private branch exchange 16 (PBX) usually combined with an automatic call distributor 16 (ACD). The PBX 16 will be recognized to be a sub-system that can route incoming telephone calls to intended call recipients, or agents. The ACD 16 will be recognized to be a sub-system that can provide call queuing and automatic wait handling of incoming telephone calls. The PBX/ACD 16 can be coupled to one or more interactive voice response systems 18 (IVR). The IVR 18 will be recognized to be a system that provides voice queries to a telephone caller. Voice queries typically direct the telephone caller through a series of selections that can be chosen by the telephone caller via button pushes on the telephone keypad.

Within the IVR queries, the telephone caller can be directed by the IVR 18 to select an option that connects the telephone caller, via the PBX/ACD 16, to one of a group of agents 20. The agents 20 can have access to agent telephones, of which agent telephone 22 is representative of all agent telephones. The agents 20 can also have access to agent computers, of which agent computer 24 is representative of all agent computers.

The PBX/ACD 16 is further coupled to a network 26 that can be provided to couple together the PBX/ACD 16, the agent computers, for example agent computer 24, a computer telephony integration (CTI) server 28, an application server 30, a database server 32, a web server 34, and an email server 36. The network 26 can correspond, for example, to an Ethernet local area network.

The IVR 18 can, among the IVR selections offered, request that the telephone caller enter “identifying information,” for example an account number, by button pushes on the telephone keypad or by voice responses from the telephone caller. Identifying information can also be automatically provided by the PBX/ACD 16 without entry by the telephone caller with a variety of methods, including dialed number identification service (DNIS) and automatic number identification (ANI). The identifying information is passed through the PBX/ACD 16 to the bus 26. The CTI 28 receives the identifying information and coordinates the identifying information with “caller data,” for example account history associated with the telephone caller, contained in the database server 32. An application program in the application server 30 can automatically provide a display of the caller data in a “screen pop” to the agent disposed upon the agent computer 24. Alternatively, the application program can reside within the agent computer 24.

When a contact center has no CTI 28, or if the screen pop is delayed by system data flow bottlenecks, the agent can manually identify the telephone caller using the agent computer 24 by manually entering the identifying information via the keyboard of the agent computer 24.

The contact center 14 can also be accessed via the Internet 37, for example by a web user who accesses a web page associated with the contact center. The web user, via the Internet 37, connects to the web server 34 for web page access. The web user can also be an email user, in which case the email user connects to the email server 36 via the Internet 37. While web page access and email access have been described herein, the invention is not limited to only these specific Internet applications. A variety of Internet applications can access a variety of servers within the contact center 14.

Virtual test systems have been applied to contact centers. For example, virtual telephone caller systems 38 have been provided to simulate telephone callers within the PSTN 12. The virtual telephone caller system 38 can generate “virtual telephone caller actions,” for example virtual telephone calls, to the contact center 14, thereby accessing the PBX/ACD 16, the IVR 18, and agent telephones, for example agent telephone 22. The virtual telephone caller system 38 can also receive contact center functions, for example an IVR audio response. With this arrangement, the IVR 18 can be tested for response accuracy and response time. The PBX/ACD 16 can be tested for agent telephone access integrity and response time.

Similarly, virtual agent telephone systems 40 have been provided that can generate “virtual agent telephone actions” to simulate agents 20 within the contact center 14 who answer telephone calls. The virtual agent telephone systems 40 can also receive contact center functions, for example automatic voice data.

As mentioned above, the various elements of the contact center 14 can provide a screen pop upon the agent computers, for example agent computer 24. Virtual agent computer systems 42 have been provided that can generate “virtual agent computer actions” and receive contact center functions, for example screen pops and accesses to the data base server 32, to test the accuracy and the speed of such screen pops and the general speed and accuracy of accesses to the database server 32. The virtual agent computer system 42 can simulate multiple agent computers similar to the agent computer 24.

Virtual web user systems 44 have been provided that can generate “virtual web user actions” and receive contact center functions to test the Internet functions of the contact center 14. For example, the virtual web user system 44 can simulate one or more web users who access the contact center web pages that reside upon the web server 34. The web connection and web server 34 can thus be tested for web page accuracy and speed. Similarly, the virtual web user system 44 can simulate multiple emails from multiple web users. The web connection and the email server 36 can be tested for accuracy and speed.

The virtual telephone caller system 38 can be used to test the IVR 18. Among the IVR tests of interest, an IVR audio response can be tested to assure that it complies with the expected response. It will be recognized that an IVR system has a variety of responses to a variety of inputs from a telephone caller, or here, from the virtual telephone caller system 38.

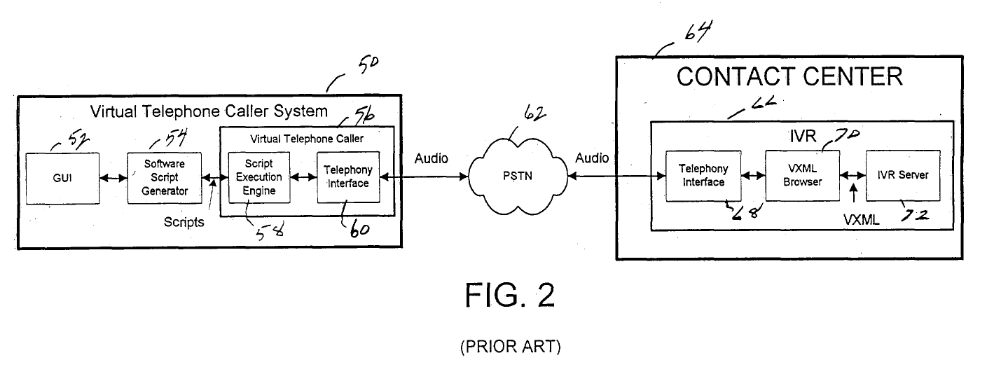

Referring now to FIG. 2, a prior art virtual telephone caller system 50, which can be the *same as or similar to the virtual telephone caller system 38 of FIG. 1, includes one or more graphical user interfaces (GUIs) 52 with which the virtual telephone caller system 50 can be programmed, and with which test results can be viewed. The GUI 52 is coupled to a software script generator 54. The software script generator 54 can provide either a software editor with which one or more test scripts can be manually entered by the user, or an automatic test script generator that can automatically provide the one or more test scripts, for example with a call flow diagram as described below in conjunction with FIG. 3. The software script generator 54 provides the one or more test scripts to the script execution engine 58, part of the virtual telephone caller 56. The script execution engine 58, in conjunction with a telephony interface 60, provides audio telephone signals to the public switched telephone network (PSTN) 62 in response to the one or more test scripts.

The audio telephone signals can have both a signaling portion and a real time (RT) portion, wherein the signaling portion corresponds to the dialing of a telephone call, and the RT portion corresponds to audio that can either be voice or audio tones associated with telephone button pushes associated with human telephone caller actions, for example dialing a call, and to human telephone caller responses to actions of the contact center 64.

The contact center 64 is also coupled to the PSTN 62 and receives the audio telephone signals generated by the virtual telephone caller system 50. The audio telephone signals are routed to an IVR 66 by the PBX/ACD (not shown), e.g. PBX/ACD 16 of FIG. 1. The audio telephone signals are received by a telephony interface 68. The telephony interface 68 provides an audio to text conversion, thereby providing text representations of the audio telephone signals to a voice extensible markup language (VXML) browser 70. The VXML browser 70 recognizes the text representations provided by the telephony interface 68 and generates a software linkage to a VXML response page, the software linkage communicated to an IVR Server 72. The IVR server, upon receiving the software linkage to the VXML response page, responds with the VXML response page. The VXML response page is converted by the VXML browser 70 into an IVR audio response. The IVR audio response can be any number of synthesized or pre-recorded voice messages. The IVR audio response is coupled to the telephony interface 68, through which the IVR audio response is coupled to the PSTN 62.

The IVR audio response, carried within the PSTN 62, is coupled to the telephony interface 60. The telephony interface 60 converts the IVR audio response to a response text. The response text is communicated to the script execution engine 58. The script execution engine 58 is programmed by the user to recognize the correct response text corresponding to the original audio telephone signal as generated by the script execution engine 58 and described above. The script execution engine 58, upon receiving, the correct response text, proceeds to next step of the test script. Otherwise, if an incorrect or unintelligible response text is received, the script execution engine 58 records the receipt and/or the content of the incorrect or unintelligible response text, and either proceeds to the next test script step, or alternatively, stops execution.

Referring now to FIG. 3, an exemplary call flow diagram 300 is associated with a virtual telephone caller system, which virtual telephone caller system can be the same as or similar to the virtual telephone caller system 38 shown in FIG. 1. The exemplary call flow diagram 300 includes a variety of icons, each icon corresponding to an action of the virtual telephone caller system or a response by the contact center (MyBank). For example, icon 310 corresponds to a telephone call to the contact center initiated by the virtual telephone caller system. Thus, the call flow diagram 300, having the icon 310, causes the telephone call to be initiated by the virtual telephone caller system.

As described above, the term “test script,” as used herein, refers to the software test script that underlies one of the variety of paths through the call flow diagram. For example, the call flow path 302 is but one call flow path, corresponding to but one test script associated with the call flow diagram 300. Each icon in a call flow diagram corresponds to a portion of one or more test scripts. Also as described above, the term “script parameters,” as used herein, refers to data that can be an input to or an output from a test script, also an input to or an output from a portion of the test script.

It will become apparent from the discussion below, that some of the script parameters can associate a test script, corresponding to one path of the call flow diagram, with one or more of a functional test, a load test, and a monitoring test. For example, a script parameter can correspond to a schedule, or a time at which the test script, or a portion of the test script will run. The test script can be programmed, for example to run once, continuously, daily, weekly, or monthly. A test script run once can be associated with a functional test. A test script run continuously can be associated with a load test. A test script run at longer the intervals can be associated with a monitoring test.

It should be understood that some of the script parameters can be provided to the test script or to the test script portion at the time that the test script is created. For example, a text string corresponding to an expected response from the contact center can be provided at the time the test script is generated. Other script parameters can be provided to the test script or to the test script portion when the script is about to be used in a test scenario. For example, the time schedule at which the script operates can be provided by the user before he initiates the test, but after the script is generated. Other script parameters can be provided to or generated by the test script or to the script test portion as the script is operating, also called run-time. For example, time latency measurements can provide latency script parameters during test script operation.

A variety of script parameters can be associated with the icon 310, including, but not limited to, a dialed telephone number, and a delay time or latency from the completion of dialing to the connection to the contact center. As an icon is merely a graphical representation corresponding to a portion of a test script, in the same way that the variety of script parameters can be associated with the portion of the test script, the variety of script parameters can also be associated with an icon.

An icon 315 corresponds to an expected response 315a by the contact center in response to the telephone call initiated at icon 310. A variety of script parameters can be associated with the icon 315, including but not limited to, the expected response 315a by the IVR within the contact center, a measured delay time or latency corresponding to the time between the connection of the telephone call and the reception of the proper IVR response 315a, a measured quality value corresponding to intelligibility associated with the received response 315a, and a measured error value corresponding to a correct or an incorrect response 315a, or corresponding to a timely or a delayed response.

Upon receipt of the response 315a, a telephone caller, or here the virtual telephone caller system, is provided with a variety of selection choices. Here, three choices 320, 350, 360 are provided. The virtual telephone caller system can provide a script parameter corresponding to a dialing of the number 1, 2, or 3, wherein selection of the number 1 thereafter follows the flow path to icon 320 corresponding to a request for a voice response that will indicate a bank balance. Similarly, each other icon of the call flow diagram 300 can be associated with a respective variety of script parameters.

It should be appreciated that the exemplary call flow diagram 300 provides three primary call flow branches, a first call flow branch beginning at icon 320, a second call flow branch beginning at icon 350, and a third call flow branch beginning at icon 360. It should be understood that the selection from among the three call flow branches beginning at icons 320, 350, 360 respectively is generated by the virtual telephone caller system. It should be further understood that each of the above call flow branches are associated with a respective one of three test scripts.

It should be further appreciated that the exemplary call flow diagram 300 provides a call flow branch at icon 336. If, for example, at icon 335, the virtual telephone caller system does not respond with the mother's maiden name, the IVR at the contact center will query for the date of birth (DOB) corresponding to the icon 336. It should be understood that the call flow branch to the icon 336 is initiated by the contact center. It should however, also be understood that the virtual telephone caller system can force this condition by generating an incorrect or missing mother's maiden name at icon 335.

While three primary call flow branches are shown, it will be appreciated that any number of call flow branches can be provided by a call flow diagram, and the call flow branches can be initiated from any icon within the call flow diagram. As described above, a “call flow path,” as used herein, refers to a translation along a path of interconnected icons (e.g., 302, FIG. 3).

It should also be appreciated that while particular types of script parameters have been described above in association with particular icons, any number of script parameters can be associated with a call flow diagram icon and the underlying test script portion.

The call flow diagram 300 corresponds to underlying test scripts, and each of the call flow icons 305-315, 320-370 corresponds to an underlying,portion of the test scripts. As described above, in an alternate embodiment the test scripts can be generated in a programming language without use of the call flow diagram. The test scripts, for example, can be written in Visual Basic. In other embodiments, the test scripts can be generated with other graphical user interfaces, not shown. It should be understood that the script parameters described herein are associated either with the test script or with portions of the test script. In accordance with the present invention, the test script can be generated by a variety of means, the call flow diagram being only one such means, the call flow diagram used descriptively herein.

From further discussion below it will become further apparent that some of the script parameters, an in particular, usage script parameters, can be associated with a type of test, for example, with a functional test, a load test, or a monitoring test. Thus, a call flow diagram, for example the call flow diagram 300, and the underlying test script, can be used without further modification for a variety of text contexts. It should be apparent that the test script must be written to accept the differentiating script parameters.

Others of the icons of the call flow diagram 300 are not explicitly described herein as they will be readily understood by one of ordinary skill in the art.

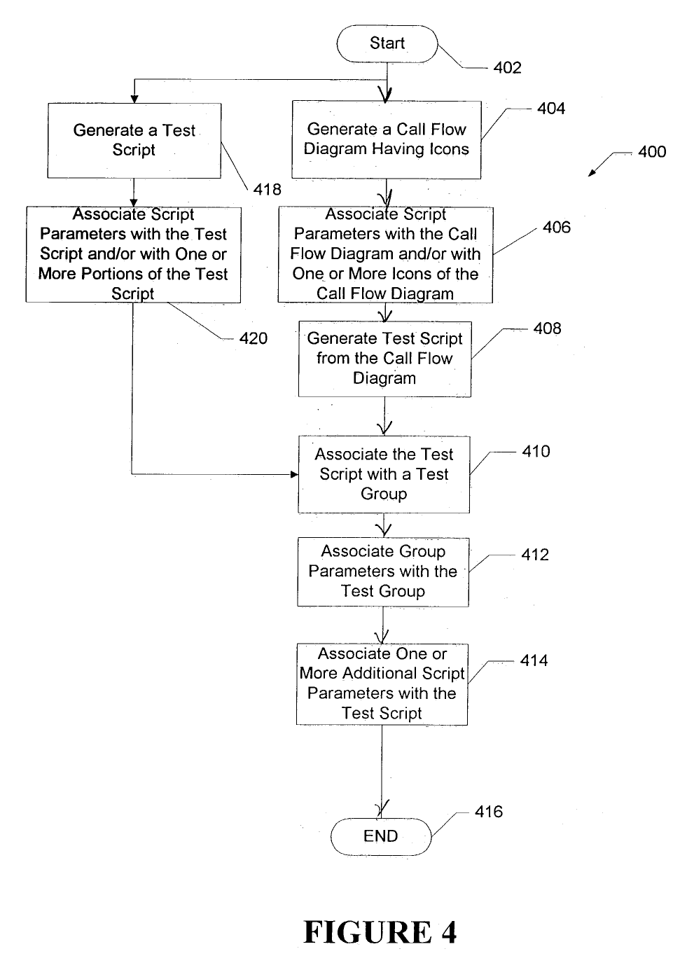

Referring now to FIG. 4, a process 400 for test script generation and for test type differentiation begins at step 404, at which a call flow diagram is generated. At step 406, the test script designer associates a variety of “characteristic script parameters” with the call flow diagram and/or to particular icons of the call flow diagram.

Script parameters can be classified as either “characteristic script parameters” or “usage script parameters.” In general, the characteristic script parameters are statically provided to a test script or a portion of a test script at a time before the program is run, for example, when the test script is created. In contrast, the usage script parameters can be provided to a test script or to a portion of a test script by a user at run-time, or at any time after the test script is generated. The usage script parameters, in particular, can be related to a behavior of a test script that allows the test script to provide a functional test, a load test, or a monitoring test.

The characteristic script parameters include a variety of types of script parameters, including, but not limited to, “output script parameters,” “input script parameters,” and “measurement script parameters,” and “logging script parameters.”

The output script parameters, are provided within the test script. For example, the output script parameters can include a text string associated with a voice output provided by the virtual telephone caller system.

The “input script parameters,” are provided by the contact center for comparison with expected responses provided by the virtual telephone caller system. For example, the input script parameters can include a voice response firm the contact center, the voice response converted to a text string for input to the test script and subsequent comparison with an expected text string.

The measurement script parameters can be generated by measurements performed by the virtual telephone caller system. For example, the measurement script parameters can include a latency time value corresponding to a time difference between an action performed by the virtual telephone caller system and a response generated by the contact center.

The logging script parameters, associated with an icon of a call flow diagram, allow a user to specify whether data associated with the icon is to be recorded.

The usage script parameters, which can be provided by a user at run-time, include a variety of types of script parameters, including, but not limited to, “scheduling script parameters,” “resource allocation script parameters,” and “alerting script parameters.”

The scheduling script parameters allow a user to specify, at run-time, the time of actions to be taken by the virtual telephone caller system. For example, the scheduling script parameters can include a start time value and/or a stop time value, corresponding to the time at which a virtual telephone caller system action is to be performed corresponding to the call flow diagram or to the icon.

The resource allocation script parameters can include a list of channels that the user can specify at run-time. For example, the resource allocation script parameters can include a list of output channels, each output channel corresponding to a virtual telephone caller.

The alerting script parameters allow the user to specify, at run-time, thresholds associated with measured script parameters. Other alerting script parameters allow a user to assign actions, which can be alerts, based upon measurements that fall outside of the thresholds. For example, if a measure time latency measurement script parameter falls outside of a maximum desired latency threshold, the operator of the virtual telephone caller system can be notified of the failure in a variety of ways, including, but not limited to, a failure indication on a graphical user interface.

At step 408, a test script is automatically generated from the call flow diagram. One or more test scripts can be generated from the call flow diagram.

At step 410, the test script is associated with a test group. The test group can, for example, correspond to a set of test scripts associated with a functional test, with a load test, or with a monitoring test. It should be appreciated that the test script can be associated with more than one test group and that the more than one test group can run either sequentially or in parallel.

At step 412, group parameters are associated with the test group. The term “group parameters,” as used herein, referred to parameters similar to the script parameters, however, the group parameters apply to a test group that can contain one or more test scripts. Thus, a group parameter has a wider reach than a script parameter. Group parameters can include, but are not limited to, a variety of resource allocation script parameters that determine on which channels a test script is run. Group parameters also include a list of the one or more test scripts associated with the group. Group parameters can be provided by a user at run-time, or at any time after the test script is generated.

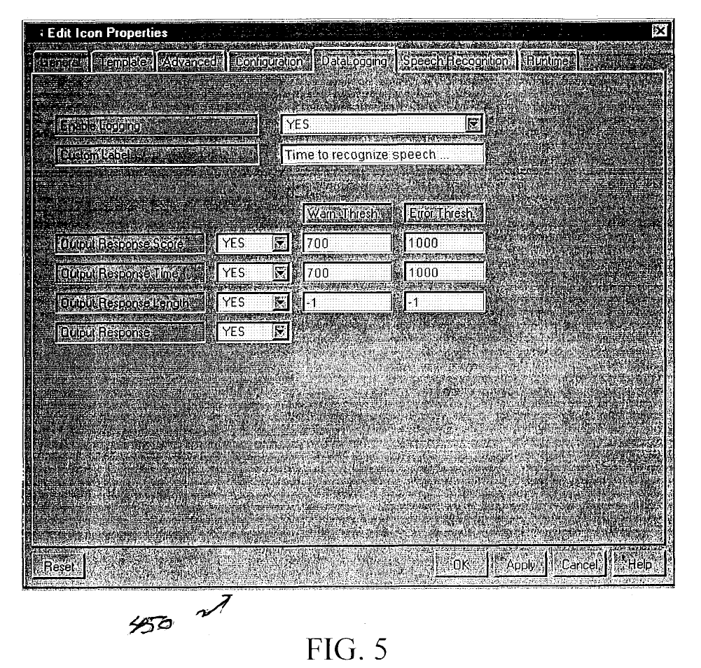

At step 414, additional script parameters, for example usage script parameters described above, can be associated with the test script, the test script having been previously associated with the test group. The group parameters of step 412 and the script parameters of step 414 will be further understood in association with FIGS. 5-16.

As described above, the variety of script parameters can be associated with the test script either at the time that the test script is generated by a test script designer, corresponding to steps 406 and 420 of FIG. 4, or at a later time, for example at or near run-time, by a user of the test script, corresponding to step 414 of FIG. 4. For example, in conjunction with the exemplary graphical user interfaces presented in FIGS. 5-16, it is described that the logging script parameters shown in FIG. 5 are provided to the test script at the time that the test script is generated.

While a call flow diagram is described, it should be appreciated that any graphical user interface (GUI) can be provided to assist with generation of the test script.

In an alternate embodiment having no such GUI, reflected by steps 418 and 420, where the call flow diagram or other GUI is not provided to generate the test script, the test script is otherwise generated at step 418, for example as a Visual Basic program. Here, the script parameters are associated with the test script or with one or more portions of the test script at step 420, essentially during the generation of the test script. Thereafter, the process of the alternate embodiment continues at step 410.

Referring now to FIG. 5, an exemplary graphical user interface 450 includes a logging script parameter that can be associated with an icon in a call flow diagram. In the exemplary graphical user interface, the logging has been turned on. The logging script parameters are provided to the test script at the time that the test script is generated. While it is described that the logging script parameters are provided at the time the test script is generated, in an alternate embodiment, the logging script parameters are provided after the test script is generated, for example, at run-time.

The graphical user interface 450 also includes a variety of alerting script parameters in the form of latency time thresholds, each in unit of milliseconds, specified at run-time, or at any time after the test script is generated. While it is described that the alerting script parameters are specified by the user of the test script at run-time as mentioned above, in an alternate embodiment, the alerting script parameters are provided at the time that the test script is generated, for example, by a test script designer.

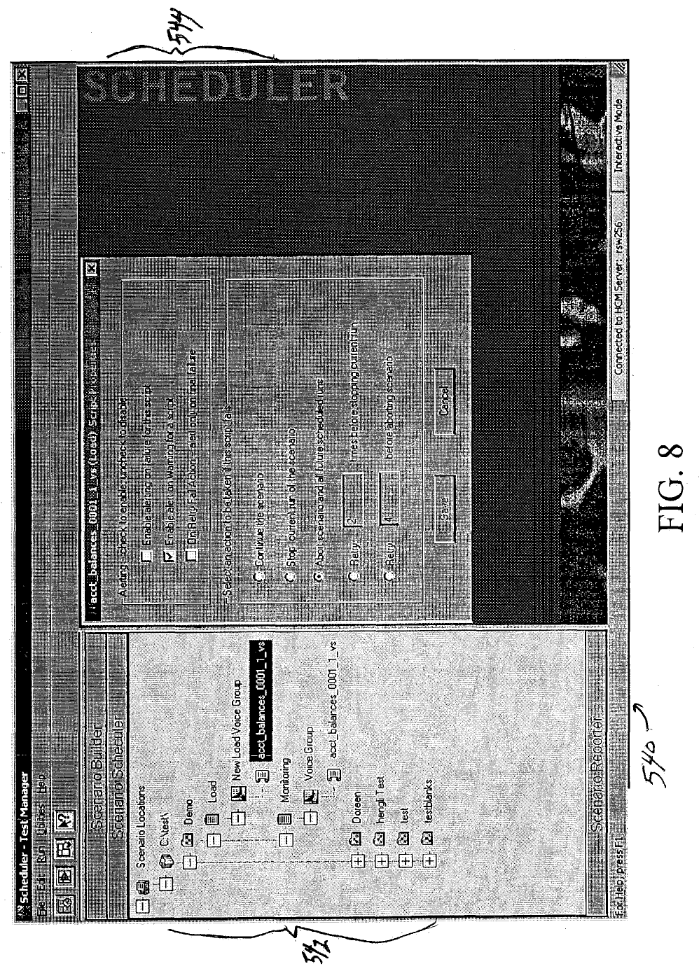

When logging is turned on, all measurements associated with an icon to which the graphical user interface 450 applies are stored. When a measured value in excess of the specified threshold is received, an alerting action can be performed. For example, an alert can be provided to the user. In an alternate embodiment, when a measured value in excess of the specified threshold is received, no alert is provided. The conditions that cause an alert and the type of alert are provided by other usage script parameters, for example the script parameters shown in conjunction with FIG. 8.

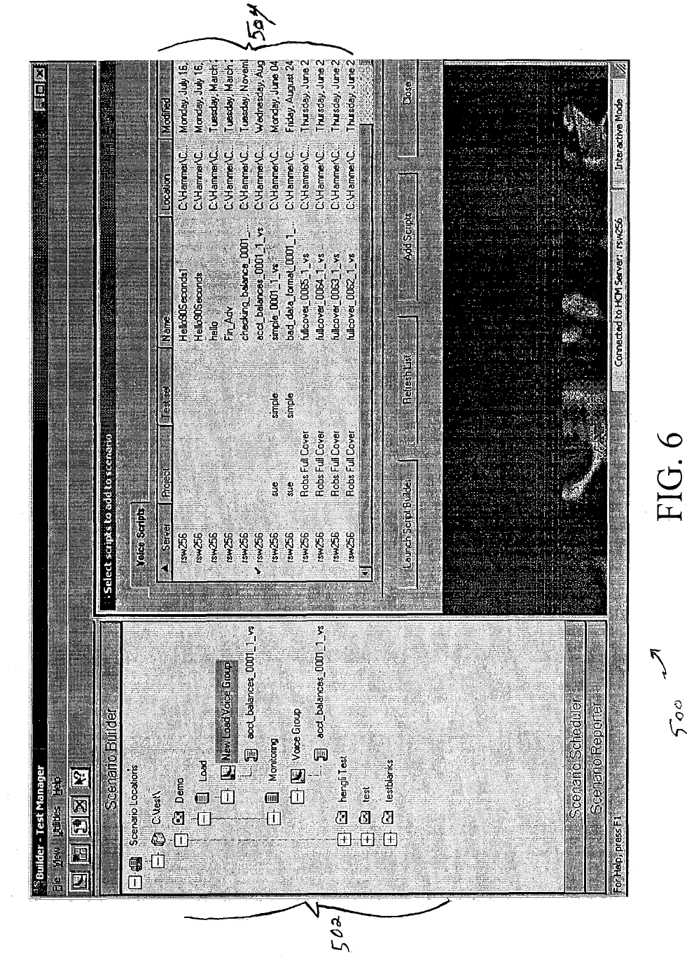

FIGS. 6-16 below are graphical user interfaces with which the user of the test script can, after the design of the test script is complete, specify a variety of usage script parameters, run-time, or at any time after test script generation. In an alternate embodiment, the usage script parameters can also be specified at the the of the test script generation, essentially being hard coded into the test script. However, to provide the test script that can be used in a variety of test contexts, or scenarios, such as the functional test, the load test, and the monitoring test, it is desirable that some or all of the usage script parameters described in conjunction with FIGS. 6-16 be available for user specification when the test script is to be used, after the test script has been generated.

Referring now to FIG. 6, an exemplary graphical user interface 500 includes a scenario tree 502 created by the user. The “Demo” folder includes a scenario called “Load” and a scenario called “Monitoring.” The user has created a load voice group called “New Load Voice Group” including a test script called “acct_balances_{—}0001_{—}1_vs.” Within the Monitoring scenario, the user has created a regular voice group called “Voice Group” including the same test script “acct_balances_{—}0001_{—}1_vs.” Similarly, the test script “acct_balances_{—}0001_{—}1_vs” could also be used in a functional test. Therefore, the test script “Acct_balances_{—}0001_{—}1_vs” is used in two different types of tests, a load test, and a monitoring test.

In order to allow the test script “acct_balances_{—}0001_{—}1_vs” to have but one instance and still to be used in more than one type of test, the test script “acct_balances_{—}0001_{—}1_vs” is provided with different usage script parameters depending upon the type of test. For example, scheduling script parameters provided to the test script “acct_balances_{—}0001_{—}1_vs” at run-time can be different depending upon whether the test script is used in a functional test, a load test, or a monitoring test. With different usage script parameters, a test script can be used in different test contexts, yet only the one instance of thee test script need be provided.

The test groups “New Load Voice Group” and “Voice Group” correspond to the test groups generally described above in conjunction with steps 410, 412 of FIG. 4. Here, however, an additional level of hierarchy can associate a plurality of test groups together into “scenarios,” for example the scenario “Load” and the scenario “Monitoring.”

It will be understood that the exemplary scenario “Load” corresponds to one or more test groups, each having one or more test scripts that are run in a sequence as a load test. It will also be understood that the scenario “Monitoring” also corresponds to one or more test groups, each having one or more test scripts that are run in a sequence as a monitoring test. As described above, the test script “acct_balances_{—}0001_{—}1_vs” can be associated with both a load test and with a monitoring test. Similarly, the system can provide a scenario (not shown) corresponding to a functional test, the functional test described above.

It should be understood that the test script “acct_balances_{—}0001_{—}1_vs” can be generated with a call flow diagram, with a programming language, or with any graphical user interface.

The process of adding a test script to a voice group is depicted in the “Select scripts to add to scenario” window 504. The user selects a test script or group of test scripts then presses the add script button to transfer those test scripts to the highlighted voice group in the scenario tree 502. In addition, from the “Select scripts to add to scenario” window 504 the user is able to launch a test script builder graphical user interface (not shown), for example the call flow diagram, to build these test scripts. When the user returns from the test script builder graphical user interface, the newly created test scripts are added to the script library shown listed in the “Select scripts to add to scenario” window 504.

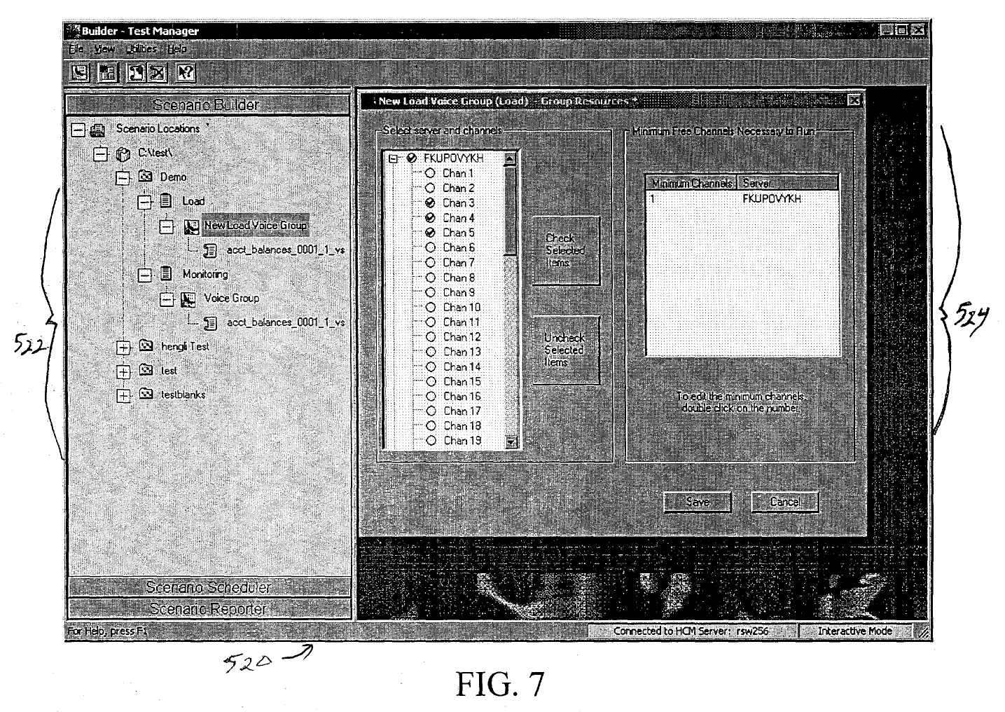

Referring now to FIG. 7, an exemplary graphical user interface 520 includes a scenario tree 522 created by the user. The “New Load Voice Group” is highlighted (selected) in the scenario tree 522. By right clicking on the “New Load Voice Group,” the user opens the “Group Resources” window 524. In the “Group Resources” window 524 the user can select resource allocation script parameters as virtual telephone caller system channels, corresponding to telephone channels, on which to run the test scripts associated with the selected “New Load Voice Group.” The selection of the channels can be done by clicking with the mouse on each channel desired or by selecting a group of channels and pressing the “Check Selected Items” button to check all the selected channels at once. In addition, the user can set the minimum number of channels that must be free on the virtual telephone caller system before the test scripts associated with the “New Load Voice Group” can begin. The selection of the channels results in the test scripts associated with the “New Load Voice Group” being simultaneously run on the selected telephone channels.

Referring now to FIG. 8, an exemplary graphical user interface 540 includes a scenario tree 542 created by the user. The “acct_balances_{—}0001_{—}1_vs” test script in the “New Load Voice Group” is highlighted (selected) in the scenario tree 542. By right clicking on the “acct_balances_{—}0001_{—}1_vs” test script, the user opens the “Script Properties” window 544.

In the top part of the “Script Properties” window 544, the user checks (enables) one or more alerting script parameters as alerting options to be used at run-time. Selection of “Enable alerting on failure for this script” results in an alert when there is a failure for the designated script. Selection of “Enable alert on warning for a script” results in an alert when there is a warning for the designated script. Selection of “On Retry Fail Action” results in an alert on final failure, only when there is still a failure after the number of retries has been completed.

In the bottom part of the “Script Properties” window 544, the user selects only one action to be taken if this script fails. Selection of “Continue the scenario” results in an alert is being generated and the scenario continues with its schedule. Selection of “Stop current run of the scenario” results in immediately stopping the Current recurrence of the scenario, but future recurrences are continued as scheduled. Selection of “Abort scenario and all future scheduled runs” results in immediately stopping the current recurrence and canceling any future recurrences. Selection of “Retry n-times before stopping current run” results in the script being retried n-times. If there is still a failure, the current run of the scenario is stopped. Selection of “Retry n-times before aborting scenario” results in the script being tried n-times. If there is still a failure, the scenario is aborted.

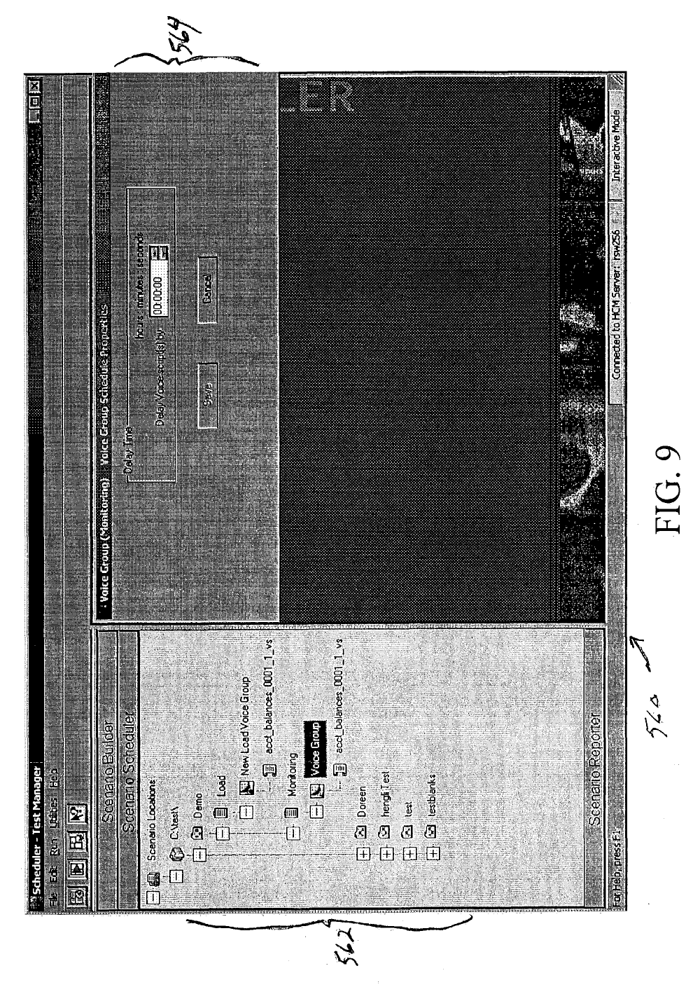

Referring now to FIG. 9, an exemplary graphical user interface 560 includes a scenario tree 562 created by the user. The “Voice Group” is highlighted (selected) in the scenario tree 562. By right clicking on the “Voice Group” the user opens the “Voice Group Schedule Properties” window 564.

In “Voice Group Schedule Properties” window 564 the user can set a scheduling script parameter as a “Delay Time,” firm the beginning of the scenario schedule, for the selected “Voice group.” This allows users to time stagger multiple groups in the “Monitoring” test scenario.

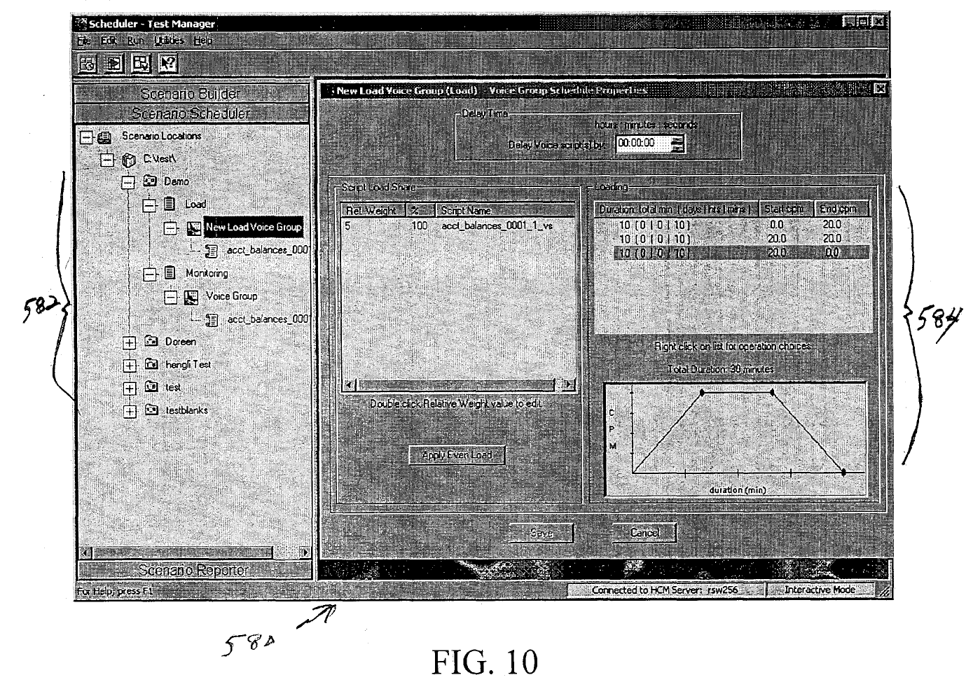

Referring now to FIG. 10, an exemplary graphical user interface 580 includes a scenario tree 582 created by the user. The “New Load Voice Group” is highlighted (selected) in the scenario tree 582. By right clicking on the “New Load Voice Group,” the user opens the “Voice Group Schedule Properties” window 584.

In the “Voice Group Schedule Properties” window 584 the user can set a scheduling script parameter as a “Delay Time,” from the beginning of the scenario schedule, for this group. This allows users to time stagger multiple groups in the “Load” test scenario. Thus, the “Delay Time” can be set in both of a load test and a monitoring test.

However, for a load test groups corresponding to a load test, more information is desired. On the left hand side of the “Voice Group Schedule Properties” window 584, the user can enter a scheduling script parameter as a relative weight (“Rel. Weight”) of each test script in the group. The indicated percentage is calculated automatically by the graphical user interface. The relative weight and the percentage correspond to a weighting associated with the selected test script in the “New Load Voice Group,” wherein a high weighting corresponds to a large amount of time that the “Load” scenario uses the selected test script in proportion to other test scripts in the “New Load Voice Group.”

In general, customer actions may be received by the contact center with different time intervals between different types of the receptions. Selection of the relative weight allows the virtual telephone caller system to simulate the different types of calls coming into the contact center. This allows the user to simulate a real life variety of users during the load test. This relative weight value is reflected in the dispatching of the test scripts during the load test.

On the right side of the “Voice Group Schedule Properties” window 584, the user defines a scheduling script parameter as a loading pattern to be used. The loading pattern corresponds to a “Load,” or a number of actions or calls per the, presented by the virtual telephone caller system to the contact center. The “Start cpm” (calls-per-minute) corresponds to the number of actions per minute at the start of the load test scenario. “End cpm” corresponds to the number of actions per minute at the end of the load test scenario. The user right clicks in the upper “Loading” window to add, delete, or modify an entry. The user enters the “Duration” time, the “Start cpm,” and the “End cpm.” for each entry. As each entry is added, the graph in the “Voice Group Schedule Properties” window 584 is automatically updated to visually indicate the loading pattern.

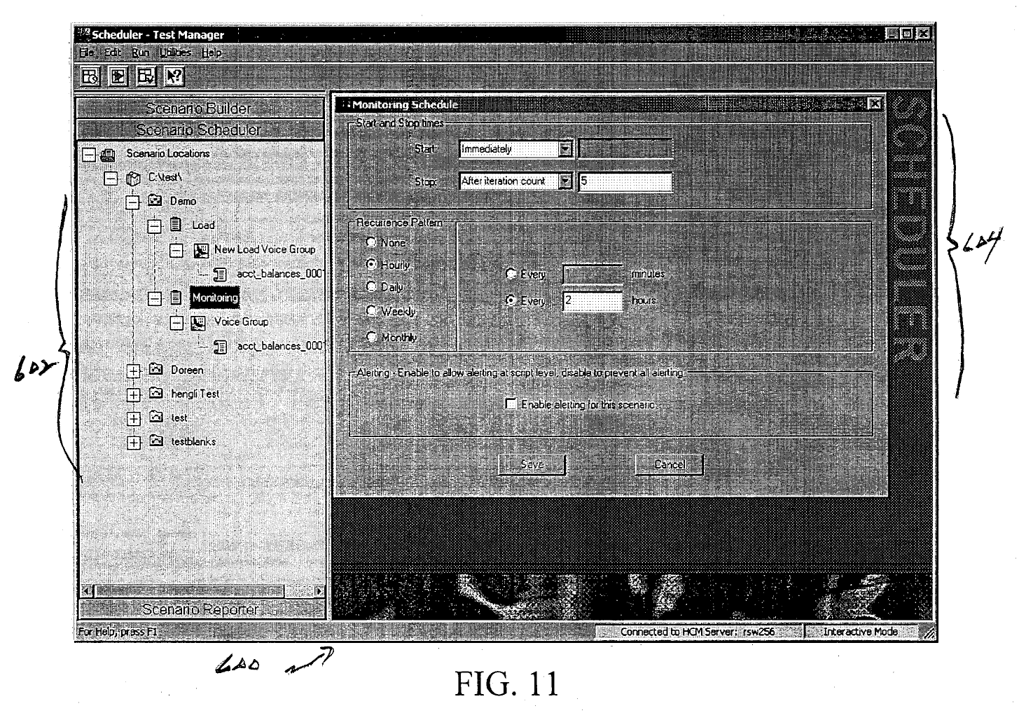

Referring now to FIG. 11, an exemplary graphical user interface 600 includes a scenario tree 602 created by the user. The “Monitoring” scenario is highlighted (selected) in the scenario tree 602. By right clicking on that “Monitoring” scenario, the user opens the “Monitoring Schedule window 604.

The “Monitoring Schedule” window 604 allows the user to set scheduling script parameters as “Start and Stop times,” and a “Recurrence Pattern.” The user can also set an alerting script parameter as enable/disable “Alerting” for the selected “Monitoring” scenario. The start time can include options to start immediately, to start at a specific time (user enters the date and time), and to start after a delay (user enters the delay time before the scenario is run). The stop time can include options to not stop, to stop after an iteration count (indicates how many times the scenario is run), and to stop at specified time (indicates the time the scenario stops running).

The “Monitoring Schedule” window 604 allows a user to set an alerting at script level. The user checks an “Enable alerting for this scenario” box to enable the alerting at script level for the whole scenario or unchecks this box to disable the alerting at script level for the whole scenario.

The “Monitoring Schedule” window allows a user to set a scheduling script parameter as a “Recurrence Pattern.” The recurrence pattern defines how often the selected “monitoring” scenario is run. The user sets the recurrence to “None” to indicate no recurrence. Here, the user has chosen to run the scenario every 2 hours. Exemplary graphical user interfaces associated with different recurrence patterns are depicted in FIGS. 11-14 below.

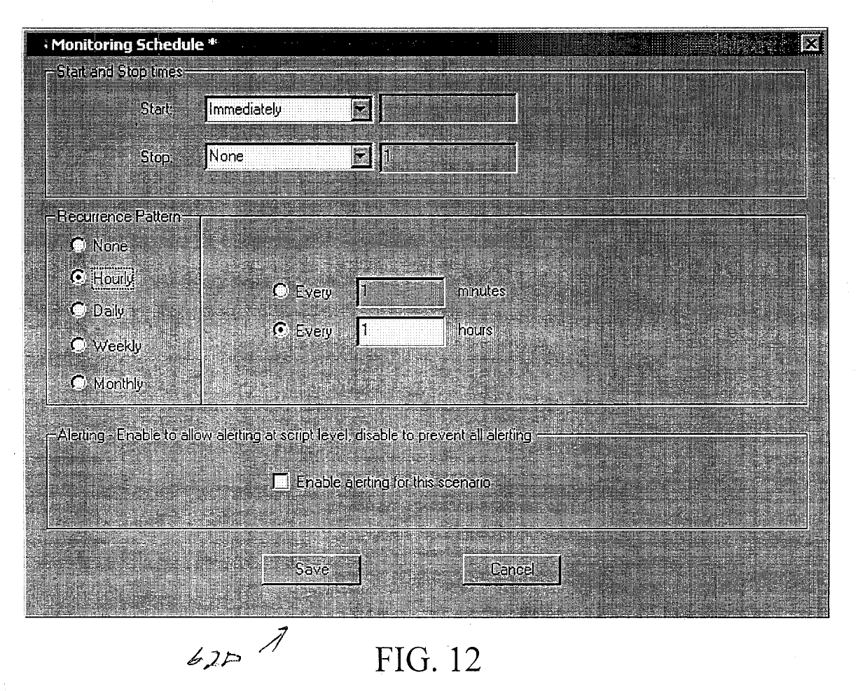

Referring now to FIG. 12, an exemplary graphical user interface 620 corresponds to the “Monitoring Schedule” window 604 of FIG. 11. Here, when the user selects “Hourly” recurrence, the user can set the selected scenario to run every “n” minutes or every “n” hours.

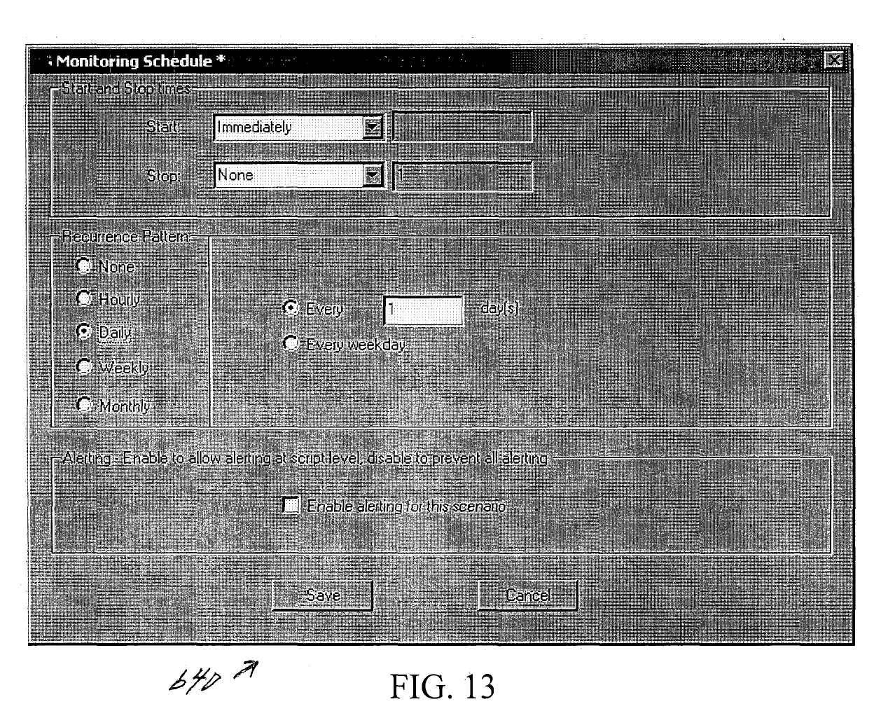

Referring now to FIG. 13, an exemplary graphical user interface 640 corresponds to the “Monitoring Schedule” window 604 of FIG. 11. Here, when the user selects “Daily” recurrence, the user can set the selected scenario to run every “n” days or every weekday.

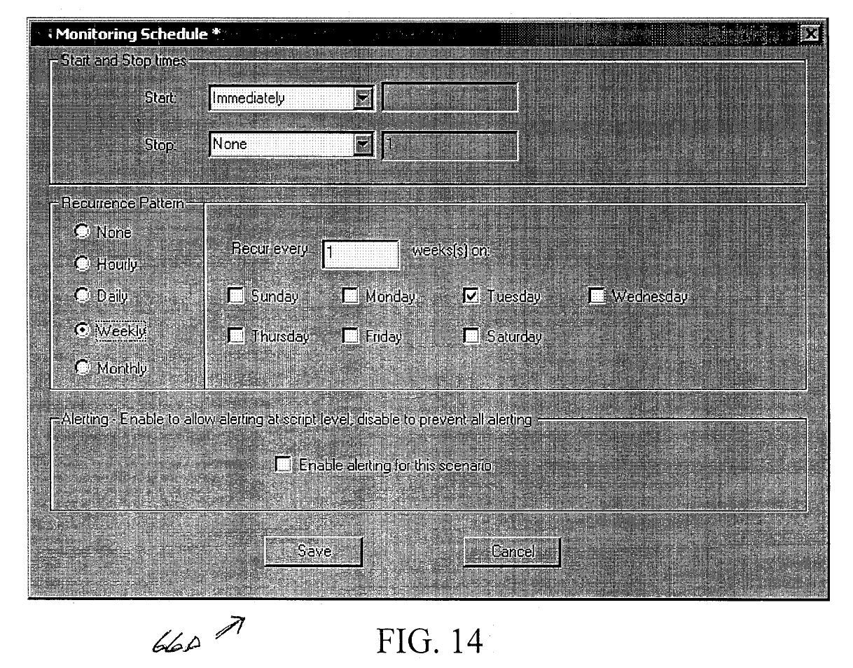

Referring now to FIG. 14, an exemplary graphical user interface 660 corresponds to the “Monitoring Schedule” window 604 of FIG. 11. Here, when the user selects “Weekly” recurrence, the user can set the recurrence to be every “n” weeks, on a particular day or days of the week.

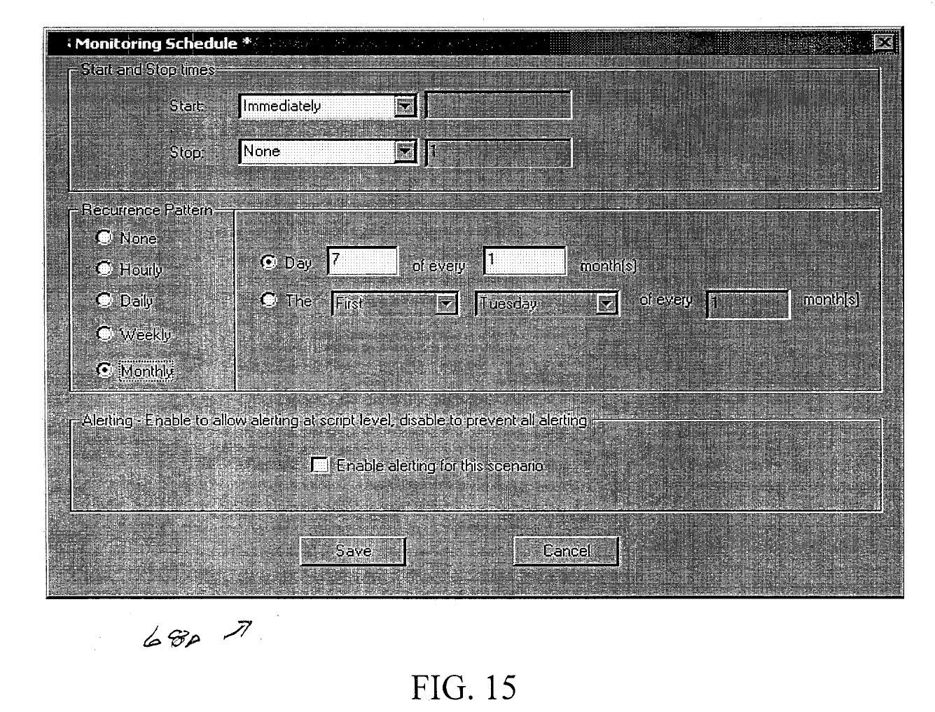

Referring now to FIG. 15, an exemplary graphical user interface 680 corresponds to the “Monitoring Schedule” window 604 of FIG. 11. Here, when the user selects “Monthly” recurrence, the user can set the recurrence to be every “nth” day of every “mth” month or the user can pick one day to run the scenario every “nth” month.

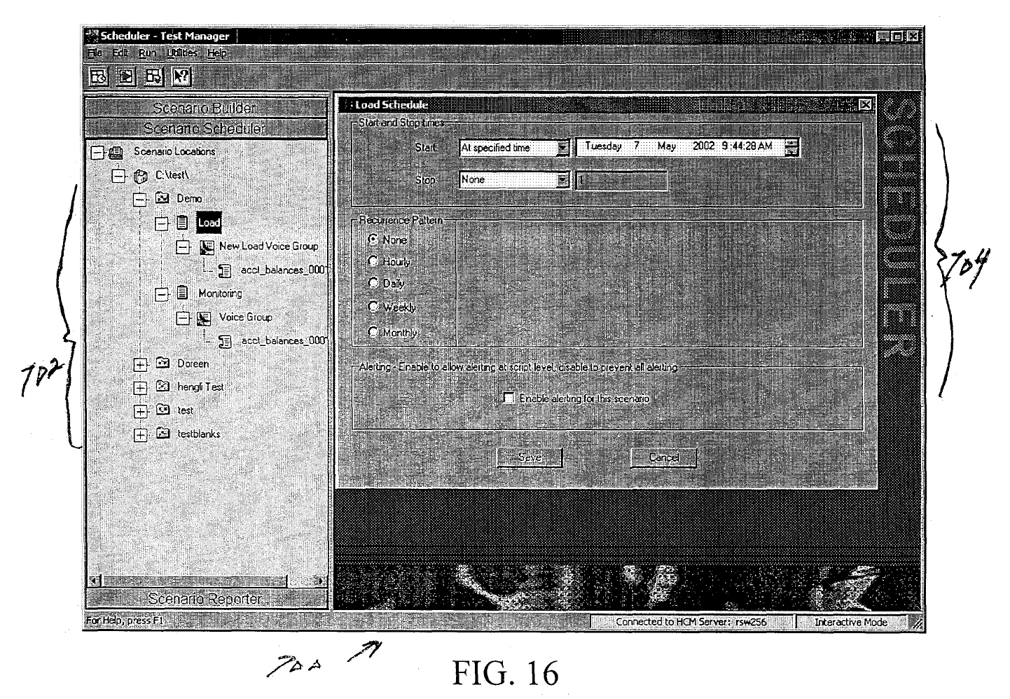

Referring now to FIG. 16, an exemplary graphical user interface 700 includes a scenario tree 702 created by the user. The “Load” scenario is highlighted (selected) in the scenario tree 702. By right clicking on the “Load” scenario the user opens the “Load Schedule” window 704. The “Load Schedule” window 704 allows the user to set the start and stop values for the scenario, the recurrence pattern, and enable/disable the alerting for the entire scenario.

The “Load Schedule” window 704 allows the user to set scheduling script parameters as a “Start and Stop times,” and a “Recurrence Pattern.”The user can also set an alerting script parameter as enable/disable “Alerting” for the selected “Monitoring” scenario. The start time can include options to start immediately, to start at a specific time (user enters the date and time), and to start after a delay (user enters the delay time before the scenario is run). The stop time can include options to not stop, to stop after an iteration count (indicates how many times the scenario is run), and to stop at specified time (indicates the time the scenario stops running).

Typically the user does not set a recurrence pattern for load testing, but if so desired, the recurrence choices are the same as those for the monitoring schedule described above.

The “Monitoring Schedule” window 704 allows over a user set an alerting script parameter as an alerting at script level. The user checks an “Enable alerting for this scenario” box to enable the alerting at script level for the whole scenario or unchecks this box to disable the alerting at script level for the whole scenario.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims. All publications and references cited herein are expressly incorporated herein by reference in their entirety.

Amendments to the Specification:

Please replace the paragraph beginning at page 1, line 6 with the following amended paragraph.

This application claims the benefit under 35 U.S.C. § 19(e) of U.S. Provisional Application No. 60/390,775 filed Jun. 21, 2002 which application is hereby incorporated herein by reference in its entirety.

What is claimed is:

1. A method for generating a test script associated with a virtual telephone caller system used to test a contact center, the method comprising:
receiving a test script having one or more test script portions; and
associating script parameters at a first time with at least one of the test script and at least one of the test script portions, wherein the script parameters are related to a behavior of the test script that allows the test script to provide two or more of a functional test, a load test, and a monitoring test.

2. The method of claim 1, wherein the functional test corresponds to a test of the contact center which can be run at a time corresponding to a time of formation of the contact center or to a time of adding new features to the contact center in order to test the general function of the contact center.

3. The method of claim 1, wherein the load test corresponds to a test of the contact center which can be run while the contact center is in operation and which applies a plurality of simulated telephone calls to the contact center in order to test the load handling capability of the contact center.

4. The method of claim 1, wherein the monitoring test corresponds to a test of the contact center which is run from time to time or continually while the contact center is in operation in order to continually test the general functions of the contact center.

5. The method of claim 1, wherein the first time corresponds to a time after the test script is generated.

6. The method of claim 1, wherein the script parameters include at least one of a logging value, a threshold value, a channel value, an alerting enable value, an alerting options value, a delay time value, a relative weight value, a duration value, a start calls-per-minute (cpm) value, a stop cpm value, a start time value, a stop time value, a recurrence pattern value, and a recurrence value.

7. The method of claim 6, wherein the logging value corresponds to a binary value that indicates whether logging of data is to be performed, the threshold value corresponds to a value associated with a test of the contact center which is used to determine fail data, the channel value corresponds to a telephone channel used to provide a test to the contact center, the alerting enable value corresponds to a binary value which turns alerting on or off, the alerting options value corresponds to an action to be taken in the event of a test failure, the delay time value corresponds to a delay time before an associated test is performed, the relative weight value corresponds to a percentage to time associated with a test script corresponding to the relative amount of time during a test that the test script will run in a group of tests, the duration value corresponds to the total duration of a test, the start cpm value corresponds to the number of calls per time at the beginning of a test, the stop cpm value corresponds to the number of calls per time at the end of a test, the start time value corresponds to a time at which a test is started, the stop time value corresponds to a time at which a test is ended, the recurrence pattern value corresponds to a gross time interval at which a test is run, and the recurrence value corresponds to a fine time interval at which a test is run.

8. The method of claim 1, further including:
associating the test script with two or more test groups at a second time, each test group associated with one of the functional test, the load test, and the monitoring test; and
associating group parameters with each of the at least two test groups at the second time.

9. The method of claim 8, wherein the second time corresponds to a time after the test script is generated.

10. The method of claim 8, wherein the group parameters include at least one of a logging value, a threshold value, a channel value, an alerting enable value, an alerting options value, a delay time value, a relative weight value, a duration value, a start calls-per-minute (cpm) value, a stop cpm value, a start time value, a stop time value, a recurrence pattern value, a recurrence pattern value, and a recurrence value.

11. The method of claim 10, wherein the logging value corresponds to a binary value that indicates whether logging of data is to be performed, the threshold value corresponds to a value associated with a test of the contact center which is used to determine fail data, the channel value corresponds to a telephone channel used to provide a test to the contact center, the alerting enable value corresponds to a binary value which turns alerting on or off, the alerting options value corresponds to an action to be taken in the event of a test failure, the delay time value corresponds to a delay time before an associated test is performed the relative weight value corresponds to a percentage to time associated with a test script corresponding to the relative amount of time during a test that the test script will run in a group of tests, the duration value corresponds to the total duration of a test, the start cpm value corresponds to the number of calls per time at the beginning of a test, the stop cpm value corresponds to the number of calls per time at the end of a test, the start time value corresponds to a time at which a test is started, the stop time value corresponds to a time at which a test is ended, the recurrence pattern value corresponds to a gross time interval at which a test is run, and the recurrence value corresponds to a fine time interval at which a test is run.

12. The method of claim 1, further including:
associating one or more additional script parameters with the test script at a third time; and
generating the test script having the one or more test script portions.

13. The method of claim 12, wherein the third time corresponds to a time of the generating the test script.

14. The method of claim 12, wherein the additional script parameters include at least one of a logging value, threshold value, a channel value, an alerting enable value, an alerting options value, a delay time value, a relative weight value, a duration value, a start calls-per-minute (cpm) value, a stop cpm value, a start time value, a stop the value, a recurrence pattern value, and a recurrence value.

15. The method of claim 14, wherein the logging value corresponds to a binary value that indicates whether logging of data is to be performed, the threshold value corresponds to a value associated with a test of the contact center which is used to determine fail data, the channel value corresponds to a telephone channel used to provide a test to the contact center, the alerting enable value corresponds to a binary value which turns alerting on or off, the alerting options value corresponds to an action to be taken in the event of a test failure, the delay time value corresponds to a delay time before an associated test is performed, the relative weight value corresponds to a percentage to time associated with a test script corresponding to the relative amount of time during a test that the test script will run in a group of tests, the duration value corresponds to the total duration of a test, the start cpm value corresponds to the number of calls per time at the beginning of a test, the stop cpm value corresponds to the number of calls per time at the end of a test, the start time value corresponds to a time at which a test is started, the stop time value corresponds to a time at which a test is ended, the recurrence pattern value corresponds to a gross time interval at which a test is run, and the recurrence value corresponds to a fine time interval at which a test is run.

16. A computer program medium having computer readable code thereon for testing a contact center, the medium comprising:
instructions for receiving the test script having one or more test script portions; and
instructions for associating script parameters at a first time with at least one of the test script and at least one of the test script portions, wherein the script parameters are related to a behavior of the test script that allows the test script to provide two or more of a functional test, a load test, and a monitoring test.

17. The computer program medium of claim 16, wherein the functional test corresponds to a test of the contact center which can be run at a time corresponding to a time of formation of the contact center or to a time of adding new features to the contact center in order to test the general function of the contact center.

18. The method of claim 16, wherein the load test corresponds to a test of the contact center which can be run while the contact center is in operation and which applies a plurality of simulated telephone calls to the contact center in order to test the load handling capability of the contact center.

19. The method of claim 16, wherein the monitoring test corresponds to a test of the contact center which is run from time to time or continually while the contact center is in operation in order to continually test the general functions of the contact center.

20. The computer program medium of claim 16, wherein the first time corresponds to a time after the test script is generated.

21. The computer program medium of claim 16, wherein the script parameters include at least one of a logging value, a threshold value, a channel value, an alerting enable value, an alerting options value, a delay time value, a relative weight value, a duration value, a start calls-per-minute (cpm) value, a stop cpm value, a start time value, a stop time value, a recurrence pattern value, and a recurrence value.

22. The computer program medium of claim 21, wherein the logging value corresponds to a binary value that indicates whether logging of data is to be performed, the threshold value corresponds to a value associated with a test of the contact center which is used to determine fail data, the channel value corresponds to a telephone channel used to provide a test to the contact center, the alerting enable value corresponds to a binary value which turns alerting on or off, the alerting options value corresponds to an action to be taken in the event of a test failure, the delay time value corresponds to a delay time before an associated test is performed, the relative weight value corresponds to a percentage to time associated with a test script corresponding to the relative amount of time during a test that the test script will run in a group of tests, the duration value corresponds to the total duration of a test, the start calls-per-minute (cpm) value corresponds to the number of calls per time at the beginning of a test, the stop cpm value corresponds to the number of calls per time at the end of a test, the start time value corresponds to a time at which a test is started, the stop time value corresponds to a time at which a test is ended, the recurrence pattern value corresponds to a gross time interval at which a test is run, and the recurrence value corresponds to a fine time interval at which a test is run.

23. The computer program medium of claim 16, further including:
instructions for associating the test script with two or more test groups at a second time, each test group associated with one of the functional test, the load test, and the monitoring test; and
instructions for associating group parameters with each of the at least two test groups at the second time.

24. The computer program medium of claim 23, wherein the second time corresponds to a time after the test script is generated.

25. The computer program medium of claim 23, wherein the group parameters include at least one of a logging value, a threshold value, a channel value, an alerting enable value, an alerting options value, a delay time value, a relative weight value, a duration value, a start calls-per-minute (cpm) value, a stop cpm value, a start time value, a stop time value, a recurrence pattern value, a recurrence value, and an alerting enable value.

26. The computer program medium of claim 25, wherein the logging value corresponds to a binary value that indicates whether logging of data is to be performed, the threshold value corresponds to a value associated with a test of the contact center which is used to determine fail data, the channel value corresponds to a telephone channel used to provide a test to the contact center, the alerting enable value corresponds to a binary value which turns alerting on or off, the alerting options value corresponds to an action to be taken in the event of a test failure, the delay time value corresponds to a delay time before an associated test is performed, the relative weight value corresponds to a percentage to time associated with a test script corresponding to the relative amount of time during a test that the test script will run in a group of tests, the duration value corresponds to the total duration of a test, the start cpm value corresponds to the number of calls per time at the beginning of a test, the stop cpm value corresponds to the number of calls per time at the end of a test, the start time value corresponds to a time at which a test is started, the stop time value corresponds to a time at which a test is ended, the recurrence pattern value corresponds to a gross time interval at which a test is run, and the recurrence value corresponds to a fine time interval at which a test is run.

27. The computer program medium of claim 16, further including:
instructions for associating one or more additional script parameters with the test script at a third time, and
generating the test script having the one or more test script portions.

28. The computer program medium of claim 27, wherein the third time corresponds to a time of the generating the test script.

29. The computer program medium of claim 27, wherein the additional script parameters include at least one of a logging value, threshold value, a channel value, an alerting enable value, an alerting options value, a delay time value, a relative weight value; a duration value, a start calls-per-minute (cpm) value, a stop cpm value, a start time value, a stop time value, a recurrence value.

30. The computer program medium of claim 29, wherein the logging value corresponds to a binary value that indicates whether logging of data is to be performed, the threshold value corresponds to a value associated with a test of the contact center which is used to determine fail data, the channel value corresponds to a telephone channel used to provide a test to the contact center, the alerting enable value corresponds to a binary value which turns alerting on or off, the alerting options value corresponds to an action to be taken in the event of a test failure, the delay time value corresponds to a delay time before an associated test is performed, the relative weight value corresponds to a percentage to time associated with a test script corresponding to the relative amount of the during a test that the test script will run in a group of tests, the duration value corresponds to the total duration of a test, the start cpm value corresponds to the number of calls per time at the beginning of a test, the stop cpm value corresponds to the number of calls per time at the end of a test, the start the value corresponds to a time at which a test is started, the stop time value corresponds to a time at which a test is ended, the recurrence pattern value corresponds to a gross time interval at which a test is run, and the recurrence value corresponds to a fine time interval at which a test is run.

31. An apparatus for testing a contact center, comprising:
a graphical user interface adapted to allow a user to provide script parameters to a test script to allow the test script to be run in two or more of a functional test, a load test, and a monitoring test associated with the contact center.

32. The method of claim 31, wherein the functional test corresponds to a test of the contact center which can be run at a time corresponding to a time of formation of the contact center or to a time of adding new features to the contact center in order to test the general function of the contact center.

33. The method of claim 31, wherein the load test corresponds to a test of the contact center which can be run while the contact center is in operation and which applies a plurality of simulated telephone calls to the contact center in order to test the load handling capability of the contact center

34. The method of claim 31, wherein the monitoring test corresponds to a test of the contact center which is run from time to time or continually while the contact center is in operation in order to continually test the general functions of the contact center.
